(19) United States
(12) Patent Application Publication
(10) Pub. No.: US 2004/0073333 A1
(43) Pub. Date: Apr. 15, 2004

(54) System, method, and program for sorting objects

(76) Inventor: Eric A. Brill, San Francisco, CA (US)

Correspondence Address: Barnes & Thornburg, 11 South Meridian Street, Indianapolis, IN, 46204, US

(21) Appl. No.: 10/432,205

(22) PCT Filed: Nov. 27, 2001
(86) PCT No.: PCT/US01/44195

(51) Int. Cl. G06F 7/00

(52) U.S. Cl. 700/224

(57) ABSTRACT

An object sorting system (100) includes a first sorting matrix (300), a second sorting matrix (200) crossing said first sorting matrix (300), and a control system (120) for directing the sorting of objects (110) to one of a plurality of sort destinations (501).

### BACKGROUND AND SUMMARY OF THE INVENTION

This invention relates to the field of sorting and handling objects such as pieces of mail, including parcels, and articles intended for commercial or industrial use. More particularly-the invention relates to a transfer and sorting system useful in such operations as a hub facility of a parcel delivery system, a warehouse or distribution facility in which products ordered by customers are selected and packed for delivery, and similar operations in which items are stored for later use or distribution as inventory, raw materials, work in process or parts.

Generally, in a parcel delivery system, packages are picked up from various locations for ultimate transport to a large number of final destinations. To meet a rigorous delivery schedule and provide accurate deliveries, a parcel delivery company uses various manual and/or automated sorting and transfer systems to match each incoming package with proper transport to the destination of the package.

Simple belt and roller conveyor systems are often used in such parcel sorting systems to move parcels from incoming loading docks to outgoing transport. Typically, conveyors carry parcels unloaded from a truck to a worker who manually sorts them by reading address information on shipping labels attached to the packages. The worker then places the parcels onto receiving conveyors or chutes which carry the parcels either to a loading dock for loading onto outgoing trucks, or to another sorting station for a narrower breakdown of destinations.

Conveyor diverter assemblies have been developed to automate and expedite handling of articles in conveyor systems. Examples appear in U.S. Pat. No. 4,798,275 to Leemkuil et al., and U.S. Pat. No. 4,174,774 to Bourgeois, both of which are incorporated herein by reference. However, such diverters are used primarily to divert articles from a main linear conveyor. As a result, such systems occupy a relatively large amount of space and their throughput is limited by the speed of the linear conveyor. Increasing the speed of a linear conveyor often requires the use of more expensive equipment and control systems, and such efforts are often limited by such factors as the varying inertia of sorted articles, precise timing requirements and increased maintenance costs. In some conveyor-based systems, throughput is enhanced without increasing conveyor speed by the use of pre-sorting subsystems which route an object to one of multiple linear conveyors depending on the object's destination. Such pre-sorting subsystems typically occupy substantial additional space, however, and often add considerable additional cost to the system. Throughput gains resulting from the use of multiple linear conveyors are partly offset by the additional time required by the pre-sort operation.

Various other systems have been developed to achieve the triple objectives of high throughput, compact size and low cost. For example, in the rotary sorter system shown in U.S. Pat. No. 5,284,252 to Bonnet, which is incorporated herein by reference, destination codes printed on packages are machine-read, and the packages are transferred onto powered conveyor modules mounted on a rotating distribution assembly. The individual module is then rotated and elevated or lowered into alignment with one of a plurality of destination conveyors that are spaced apart both horizontally and vertically. After such alignment, the modules rollers are operated to discharge the package onto the destination conveyor. In the Bonnet system, packages can be rapidly sorted without human intervention by an apparatus that occupies a relatively small amount of floor space. Another example is shown in U.S. Pat. No. 6,005,211 to Huang et al., incorporated herein by reference, which uses a stationary matrix of multi-directional conveyor cells to sort objects to a plurality of destinations.

Such sorting systems are of varying but limited effectiveness in achieving high throughput, compact size and low cost, particularly in circumstances requiring sortation to thousands of destinations.

### SUMMARY OF THE INVENTION

The present invention provides a compact, high-speed and efficient object sorting system based on a matrix comprising one or a plurality of closed ellipses (each an “upper loop”) of conveyor cells (“cradle”) that circulate around the upper loop in steps of a fixed length and duration, each such loop crossing, in a different plane, at about four points, each of one or a plurality of other closed ellipses (each a “lower loop”) of conveyor cells (“cradle”) that circulate around the lower loop in steps of a fixed length and duration.

According to one illustrative embodiment of the present disclosure there is presented a system for sorting objects comprising a control unit, a first conveyor sorting matrix and a second conveyor sorting matrix located below said first sorting matrix. Wherein said first and second sorting matrices are each adapted to receive and transport one or more objects to be sorted. The first matrix includes one or more primary discharge apertures for discharging said objects to said second matrix. The second matrix includes one or more primary discharge locations for discharging said objects to one or more collection areas.

According to another illustrative embodiment, an apparatus for receiving and discharging objects to be sorted by a sorting system is presented, wherein the apparatus comprises a pair of spaced apart side pieces having a slanted floor portion sandwiched therebetween the side pieces. A gate portion is movably attached to the floor portion and extends outwardly away therefrom.

According to another illustrative embodiment, a system for sorting objects is presented, the system comprising an induction assembly adapted to receive objects for sorting and an upper sorting circuit adjacent to the induction assembly and adapted to receive objects therefrom, wherein a lower sorting circuit crosses under said upper sorting circuit and is adapted to receive objects therefrom for delivery to a destination assembly adapted for receiving objects from the upper and lower sorting circuits. One or more sensor assemblies mounted to gather data on the one or more objects provide inputs to a control apparatus connected to the induction assembly, the upper sorting circuit, the lower sorting circuit, and the one or more sensor assemblies. The control apparatus sends output commands to facilitate the delivery of each object to the destination assembly.

According to another illustrative embodiment, a method is presented for sorting objects comprising the steps of providing a control unit to control the sort process of objects in a sorting matrix comprising a first and a second sorting matrix and a plurality of collection destinations. The method also provides for diverting objects. The control unit directs the transferring of an object to be sorted from the first matrix to the second matrix and the transferring of said transferred object from the second matrix to one of the collection destinations.

The present invention provides an improved object sorting system and method, particularly for use in a package sorting and delivery system, and also for use in a sorting system in a warehouse or distribution facility.

The present invention provides an object sorting system that can sort to a large number of sort destinations and yet occupy a comparatively small space relative to existing sorting systems used for similar purposes.

The present invention provides an object sorting system and method in which multiple streams of objects may be sorted simultaneously at high throughput rates despite relatively low line speeds.

The present invention provides an object sorting system and method in which an object to be sorted can be routed in advance to its sort destination, and subsequently re-routed in certain circumstances, based on the predictable future location of such object and of each earlier object.

The present invention provides an object sorting system and method in which an object to be sorted can be diverted from the sorting system for recirculation or manual processing if the object predictably cannot be routed to its sort destination without conflicting with the passage of another object through the sorting system.

The present invention provides an object sorting system and method in which an object to be sorted can be scanned for identification and then transported to its sort destination without the need to re-scan the object.

The present invention provides an object sorting system and method in which objects sorted to a specific sort destination can be grouped at such destination with other objects sorted to the same destination, and thereafter transferred as such a group for aggregation with other objects or object groups sorted to different destinations, when such distinct object groups nevertheless possess one or more common characteristics, such as the same delivery vehicle or container.

Other features and advantages of the present invention will become apparent upon review of the following detailed description of a preferred embodiment and the attached drawings.

### BRIEF DESCRIPTION OF THE DRAWINGS

FIG. 1 is a top plan view of a system according to one embodiment of the invention;

FIG. 2 is a side elevational sectional view of the outgoing run of the upper-loop sorting matrix and an end-on sectional view of the lower-loop sorting matrix of the system depicted in FIG. 1 taken generally along the line 2-2 of FIG. 1;

FIG. 3 is a is a side elevational sectional view of the return run of the upper-loop sorting matrix and an end-on sectional view of the lower-loop sorting matrix of the system depicted in FIG. 1 taken generally along the line 3-3 of FIG. 1;

FIG. 4 is partial diagrammatic view of the upper-loop sorting matrix and the lower-loop sorting matrix and a side elevation view of a take away conveyor of the system of FIG. 1;

FIG. 5 is an enlarged view of a portion of the upper-loop return-run depicted in FIG. 3;

FIG. 6 is a flow diagram depicting one embodiment of the method of the present invention; and

FIG. 7 is a block diagram showing the input signals to the control unit and the control outputs therefrom.

### DETAILED DESCRIPTION OF THE DRAWINGS

To promote an understanding of the principles of the invention, reference will now be made to a number of preferred embodiments illustrated in the drawings and specific language will be used to describe the same. It will nevertheless be understood that no limitation of the scope of the invention is thereby intended, such alterations and further modifications in the illustrated embodiments, and such further applications of the principles of the invention as illustrated therein, being contemplated as would normally occur to one skilled in the art to which the invention relates.

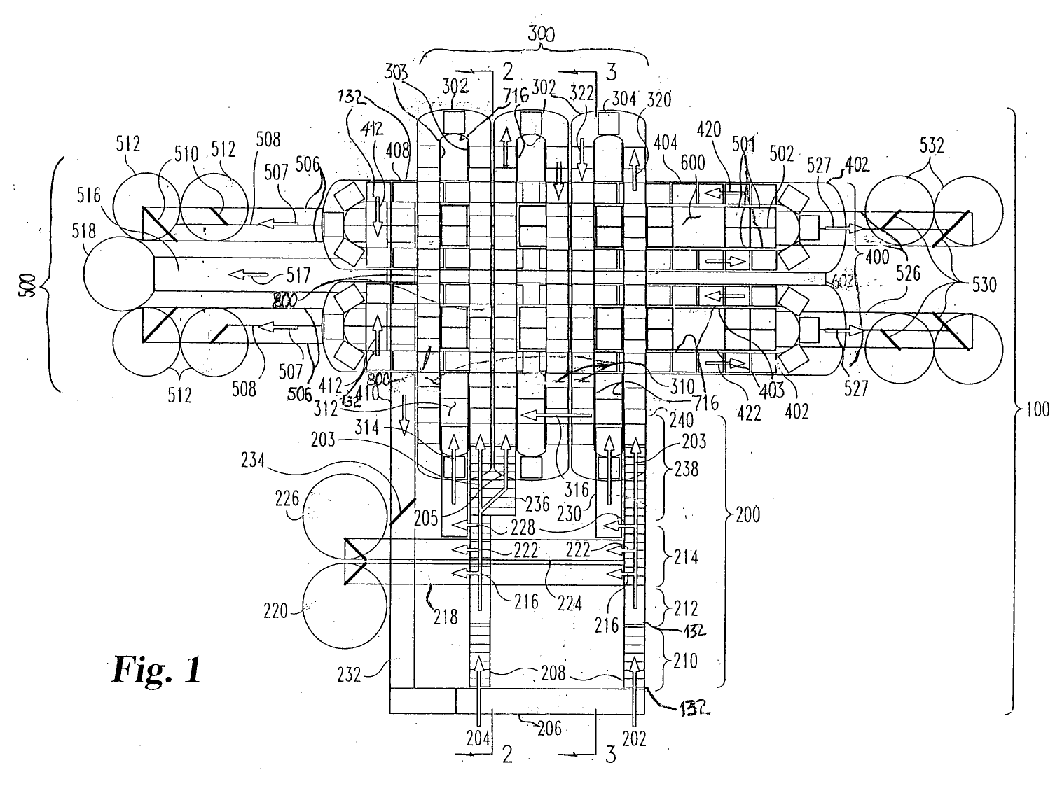

Referring now to FIGS. 1-4, in which like numerals refer to like parts throughout the several views, illustrative embodiments of the system and method embodying the present invention are shown. A sorting system 100 and method for sorting objects 110 such as parcels is provided, such system 100 comprising generally a control system 120; an induction area assembly 200; an upper-loop sorting matrix 300 consisting of longitudinally extending, generally ovate ellipses; a lower-loop sorting matrix 400 consisting of transversely extending, generally ovate ellipses; a collection-bin loading area assembly 500; a sack loading area assembly 512, 532; and a loose object loading area assembly 518, each as further described herein.

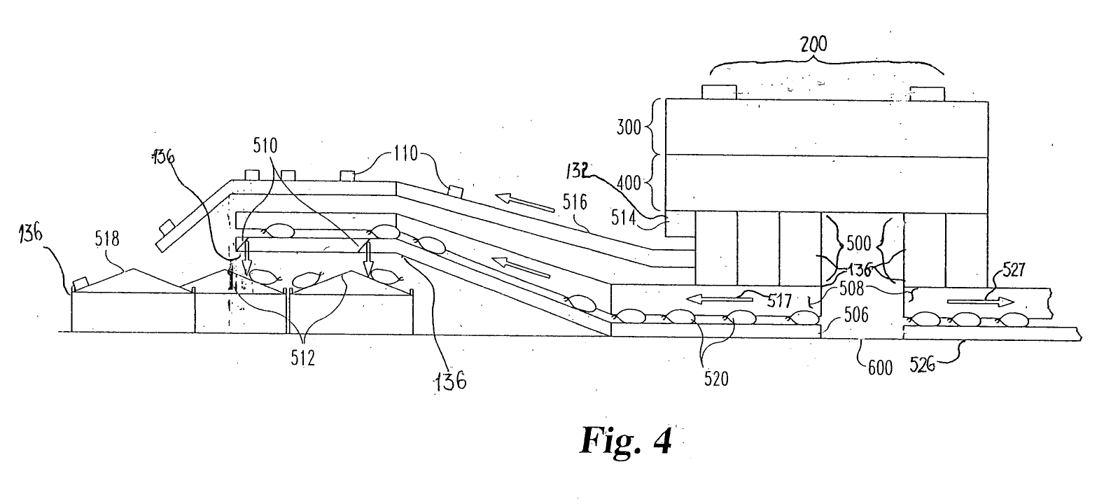

Referring to FIG. 4, it can be seen that the illustrative system 100 is a multi-level system with loading assemblies 512, 518, 532 occupying the lower levels of the system 100, with the collection-bin loading assembly 500 elevated above the loading assemblies 512, 518, 532, with the lower-loop sorting matrix 400 elevated above the collection-bin loading assembly 500, with the upper-loop sorting matrix 300 elevated above the lower-loop sorting matrix 400, and with the induction area assembly 200 elevated above the upper-loop sorting matrix 300. It will be appreciated that the vertical relationship of the different portions of the system could be changed if some of such portions also used lift devices. For example, the induction line assemblies 200 could be at a lower level relative to the other components through the use of one or more conveyors or other lift device(s) to elevate the object(s) to be sorted up to the upper-loop sort matrix 300. As will be explained further below, a series of conveyors 506, 526, underlie the collection-bin loading assembly 500, as does a walkway 600 which lies generally in the middle of the collection-bin loading assembly 500 and proceeds from the induction assembly 200 longitudinally away therefrom toward the far end of the upper-loop sorting matrix 300 in general alignment with the longitudinal axis of said matrix 300 and perpendicular to the longitudinal axis of the lower-loop sorting matrix 400, thereby separating the collection bins 501 into two sides. A number of walkways 602 extend longitudinally between and generally parallel to the conveyors 506. Said conveyors 506 proceed laterally away from walkway 600 in a first direction indicated by arrow 507, in order to serve a first side of collection bins 501, while conveyors 526 proceed laterally away from walkway 600 in a second direction directly opposite that of conveyor 506 as indicated by arrow 527, thereby serving a second side of collection bins 501.

Conveyor 516 is elevated above conveyors 506, 526 and proceeds laterally away from walkway 600. Conveyors 506, 516, 526 are generally perpendicular to walkway 600.

By way of illustration only, the vertical orientation of the system may be further described as follows. Walkway 600 is generally located at one of the lowest points of the system 100. Elevated from inches (centimeters) up to about sever feet (meters) above the walkway 600 in the area of the collection bin loading assembly 500 are the conveyors 506, 526, which then rise a further four to ten feet (1.2 m to 3 m) up to their discharge point to the holding assemblies 512, 518, 532. The collection bins 501 may rise to a level of six feet to ten feet (1.8 to 3 m) above the walkway 600. The lower-loop sorting matrix 400 may rise between four and six feet (1 m to 2 m) above the collection bins 501. The upper-loop sorting matrix 300 may in turn rise between four and six above the lower-loop sorting matrix 400. The induction assembly 200 may rise between four and six feet (1 m and 2 m) above the upper-loop sorting matrix 300, making the total height of the illustrative embodiment between 18 and 28 feet (5 m and 9 m). It will be appreciated that the addition of further levels of take away conveyors 506, 516, 526, or additional levels of collection bins 501, or additional levels of sorting matrices 300, 400, or additional levels of induction assemblies 200 would raise the overall height of the system 100. Similarly, the desire to accommodate larger objects might increase the size of the collection bins 501 as well as the vertical distance between the upper 300 and lower 400 sorting matrixes and between multiple levels of induction assemblies 200. In short, the vertical dimensions of the system 100 are not a critical aspect of the invention. Rather, the size of the largest object 110 to be sorted will be the principal factor in determining the principal vertical dimensions of the system 100.

The system 100 has the following structure and, in brief, the system and method operate as follows. In such a system, the objects 110 are delivered to the induction area assembly 200. In the induction area 200, various tasks are performed including the scanning of a label attached to each object 110 as directed by the control system 120 and as will be described in greater detail below. The control system 120 will either divert for manual processing or further pre-processing, or advance to the upper-loop sorting matrix 300, each object 110 from the induction area 200. Based on destination information taken from each object's 110 label and other information as will be explained, the control system then directs each advanced object 110 in turn to drop to the lower-loop sorting matrix 400 or instead to drop for manual processing or further pre-processing. Similarly, the control system 120 will direct each object 110 in turn to drop from the lower-loop sorting matrix 400 for manual processing or further pre-processing, or to drop to the collection-bin loading assembly 500 for transport, via conveyors 506, 516, 526, to either the sack loading assembly 512, 532 or the loose-object loading assembly 518, as appropriate. Fully processed objects 110 will then be loaded onto transportation to each object's destination. While a section specifying the detailed operation of the present invention will be presented below, further description of the system's 100 structure, with accompanying overview details of its operation, will first be presented.

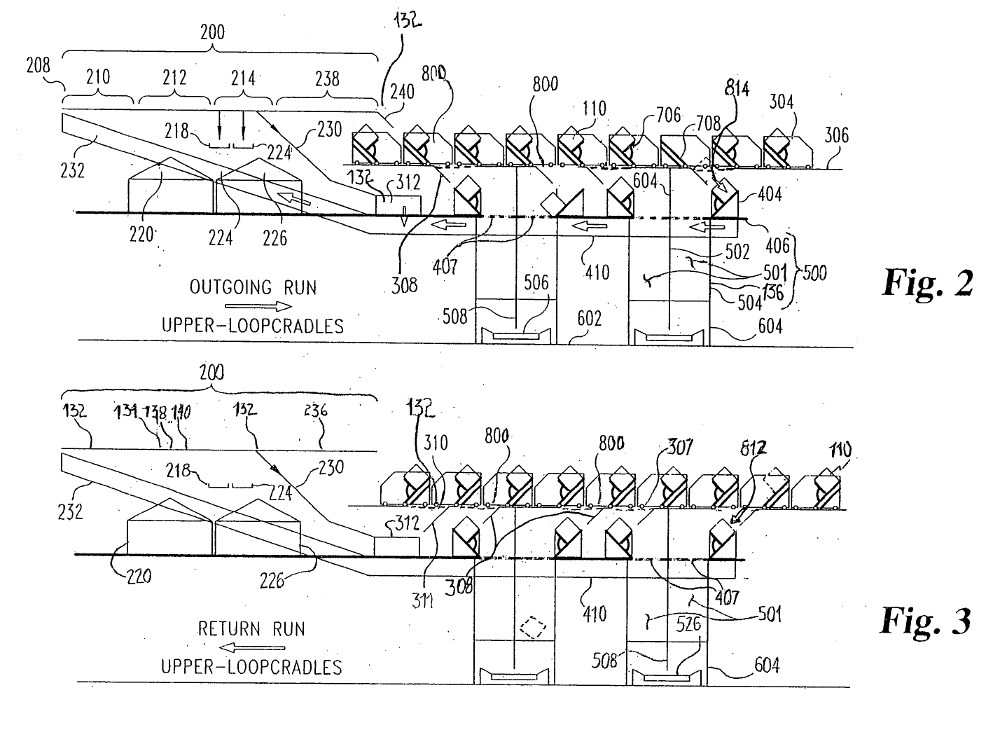

As noted, objects 110 to be sorted to one of a plurality of final sort destinations enter the system 100 at the induction line assembly 200. Two induction line assemblies 200 are depicted in the illustrative embodiment shown in FIG. 1. Each induction line assembly 200 comprises a pre-induction holding area assembly 206, which feeds one or more non-merging induction lines 202, 204, and which may include a powered-roller-conveyor, or may slope down to the intake conveyor 208 in order to use gravity to move objects 110 along. Each induction line 202, 204 has a number of processing zones comprising an intake conveyor 208, a pre-scan accumulation area assembly 210, a scan zone 212, an induction line divert area assembly 214, a post-divert accumulation area 238, an induction-line-to-upper loop discharge 240, and, optionally as in the case of induction line 204, an induction line fork 236. Each of processing zones 208, 210, 212, 214, 236, 238, 240 extends longitudinally toward the sorting matrix 300, 400 and such zones are generally aligned in spaced succession as shown in FIGS. 1 and 2. Although these zones 206, 208, 210, 212, 214, 236, 238, 240 are generally depicted in line with each other and with one of a plurality of respective upper-loop, ovate sorting loops 302 in the illustrative embodiment, they need not be. For example, each induction line 202, 204 could feed each into its associated upper loop 302 at an oblique angle, and the induction line 202, 204 and its associated upper loop 302 could be offset from each other.

Each of these processing zones 206, 208, 210, 214, 236, 238, 240 includes one or more conventional powered-roller and/or belt conveyors, with each zone configured and controlled as appropriate to perform advancement, accumulation or singulation functions as described below. Scan zone 212 further comprises scanning, weighing and dimensioning devices, and divert area 214 further comprises divert mechanisms, as further described below. It should be noted that discharge 240 could optionally be a gravity operated set of rollers or a gravity slide, or a combination of powered rollers and gravity apparatus.

Objects 110 are manually or automatically inducted at the intake 208; accumulated in the pre-scan accumulation area 210; scanned, weighed and dimensioned in the scan zone 212; diverted at the divert area 214 for manual processing or recirculation if so directed by the control system 120; and (if not diverted), accumulated in the post-divert accumulation area 238 and then advanced at the discharge assembly 240 into a cradle 304 on the upper-loop sorting matrix 300, which comprises one or a plurality of ovate sorting loops 302.

As just mentioned, the induction assembly 200 is equipped to divert for special handling objects 110 which are too large or too heavy for the system's 100 automated sorting, which have unreadable labels, for which an unobstructed path through the sorting matrix 300, 400 cannot be plotted, or which otherwise are unable to complete automated sorting. In order to accommodate such special-handling tasks, as will be further described herein, the induction assembly 200 further comprises a no-read diverter 216, a no-read divert conveyor 218, a no-read processing area assembly 220; a manual processing diverter 222, a manual processing divert conveyor 224, a manual processing area assembly 226; a recirculation diverter 228, a recirculation slide 230, a failed-to-drop conveyor 312, a recirculation conveyor 232 (FIG. 2), and a recirculation to manual processing diverter 234. The divert mechanisms 216, 222, 228 comprise one or more conventional diverters (not shown) such as a pop-up roller. The conveyors 218, 224, 312, 232 may be either a powered-roller conveyor or a belt conveyor. It will be noted that recirculation conveyor 312, which is located below the induction assembly 200 and the upper-loop sorting matrix 300, is also served later in the sorting process by recirculation slide 311, to which objects 110 are diverted from the upper-loop sorting matrix 300 if they have failed to drop where programmed to the lower-loop sorting matrix 400, for recirculation as will be described.

Objects may drop from the induction line assembly 200 to the conveyors 218, 224, the gravity slide 230, or upper-loop cradles 302, or from the gravity slide 230 to the failed-to-drop conveyor 312, by way of gravity slides (not shown, except for gravity slide 230); however, other mechanisms, such as unpowered or powered rollers, could be used. In addition, the conveyor 218, 224, 312, 232 or upper loops 300 could also be elevated over the induction line assembly 200, and if so. elevated, could use further lift mechanisms to raise objects 110 to their level. Similarly, the objects 110 drop from the respective conveyor 218, 224, 312 to the commanded destination processing area 220, 226 or recirculation conveyor 232 via a respective gravity slide or conveyor (not shown), or perhaps even in total free-fall.

In the illustrative embodiment, induction line 202 is a straight-through line feeding a single sorting loop 302. In contrast, induction line 204 is a bifurcated line having the induction line fork 236, which allows the line 204 to serve more than one sorting loop 302. The illustrative embodiment's three sorting loops 302 could also be served by three single straight-through lines, or a single induction line having two forks. Moreover, single lines and single-or multi-forked lines may be used alone or in any combination to induct objects 110 into any number of sorting loops 302 as desired. Indeed, as will be discussed further, the three-loop system 100 herein described is illustrative only. A larger system might contain, for example, twenty to fifty upper loops and twenty-five or more lower loops served by any combination of single- or multi-forked induction lines.

Objects 110, unless diverted, will move from the induction assembly 200 to the upper-loop sorting matrix 300, which, in the illustrative embodiment, comprises three horizontal, longitudinally extending, closed-oval, sorting loops, herein referred to as upper loops 302. Each loop 302 has a longitudinal axis which extends longitudinally away from and generally in line with its corresponding induction line 202, 204. Each loop 302 has a plurality of upper-loop cells 304 or cradles, one or more cradle-gate pull rods 303, a cradle-conveyor chain 716, an upper-loop floor 306, a plurality of upper-loop floor apertures 307, a plurality of upper-loop drop slides 308, a failed-to-drop slide 311, a plurality of upper loop drop points 310, 801-808, and a motor and associated drive shafts and gears (not shown).

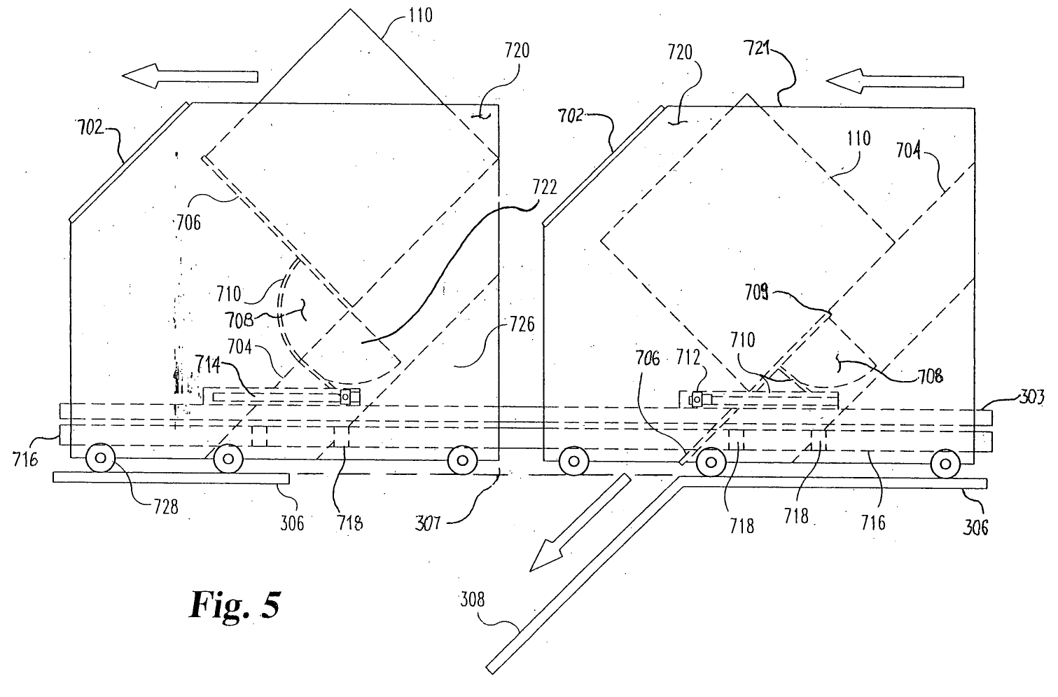

The upper-loop floor 306 may be a solid floor having apertures 307 spaced to allow for commanded drops, or it may be in the nature of a rail system. Referring to FIG. 1, each cradle-conveyor chain 716 runs the entire inner circumference of its respective loop 302. Referring to FIG. 5, the conveyor chain 716 is conventionally attached to the side of each cradle 304 using one or more cradle-conveyor attachments 718. There is a fixed interval between each of the cradles 304. Each loop's 302 pull rods 303 run one each down the inner elongated sides of the sorting loop 302. The motor (not shown) is attached using conventional gearing to each pull rod 303, and to each elongated side of the conveyor chain 716 for that particular loop 302. Such conventional gearing may include any combination of drive shafts, motor drive wheels, drive shaft wheels, direction-reversing wheels, Geneva mechanisms, cams and the like. In addition, separate motors could be used for the cradle chain 716 and the pull rods 303. While the cradle-conveyor chain 716 runs intermittently in a single forwardly direction during normal operation, the pull rods 303 move intermittently in alternate fashion between a forwardly first direction and a backwardly second direction directly opposite the first direction. The direction of travel of cradles 304 around each loop 302 will depend on the placement of such loop 302 with respect to its associated induction line discharge 240. In the illustrative embodiment in FIG. 1, for example, where the induction line discharge 240 is positioned above the left side of the associated upper loop 302, cradles 304 on such loop 302 circulate in a clockwise direction; where the induction line discharge 240 is instead positioned above the right side of the associated upper loop 302, cradles 304 on such loop 302 circulate in a counterclockwise direction.

One object 110 alone will drop into a cradle 304 and travel around the sorting loop 302 in defined movements 50 or steps, each step of the same specified length and time. As will be discussed, each step 50 will comprise a series of sub steps referred to generally as a move substep 55 and a stationary substep 56. At a predetermined step 50 during each object's 110 travel around the loop 302, the control system 120 will command each said object 110 to drop from its discrete cradle 304 either down one of the slides 308 to the lower-loop sorting matrix 400 at a predetermined one of the plurality of drop points 801-808, or, in the case of a location conflict as described below, down slide 311 to the upper failed-to-drop conveyor 312 at the failed-to-drop drop point 310 as depicted in FIGS. 2 and 3.

Generally, when directed by the control system 120, an object 110 will drop from the upper-loop sorting matrix 300 to the lower-loop sorting matrix 400, which illustratively comprises two transversely extending, closed-oval, sorting loops 402. The lower loops 402 underlie the upper loops 302 and have longitudinal axes that are generally perpendicular to the longitudinal axes of the upper loops 302. Each loop 402 has a cradle conveyor chain 716, one or more cradle-gate pull rods 403, a plurality of lower-loop cells 404 or cradles, a cradle-conveyor chain 716, a lower-loop floor 406, one or a plurality of lower-loop floor apertures 407, a failed-to-drop drop point 408, a loose-object drop point 412, a plurality of collection-bin drop points (one above each collection bin), and a motor and gearing (not shown). As noted previously, the invention is adaptable to the use of any number of upper 302 and lower 402 loops.

The lower-loop floor 406 may be a solid floor having apertures 407 spaced to allow for commanded drops, or it may be in the nature of a rail system. The loop floor 406 could instead have a single aperture comprising substantially the entire area of the oval described by the inner circumference of the lower loop 402. Referring to FIG. 1, each cradle-conveyor chain 716 runs the entire inner circumference of its respective loop 402. The conveyor chain 716 is conventionally attached to the front of each cradle 404 using one or more cradle-conveyor attachments 718. There is a fixed distance between each of the cradles 404. Each loop's 402 pull rods 403 run one each down the inner elongated sides of the sorting loop 402. The motor (not shown) is attached using conventional gearing (not shown) to each pull rod 403, and to each elongated side of the conveyor chain 716 for that particular loop 402. Such conventional gearing may include any combination of drive shafts, motor drive wheels, drive shaft wheels, direction-reversing wheels, Geneva mechanisms, cams and the like. In addition, separate motors could be used for the cradle chain 716 and the pull rods 403. While the cradle-conveyor chain 716 runs intermittently in a forwardly direction during normal operation, the pull rods 403 move intermittently in alternate fashion between a forwardly first direction and in a backwardly second direction directly opposite the first direction. The cradles 404 travel around each loop 402 in a counterclockwise direction as indicated by arrows 420, 422. The cradles 404 circulate in steps 50 synchronized with the steps 50 of the upper cradles 304. Any object 110 received into a lower-loop cradle 404 from an upper-loop cradle 304 circulates around its lower loop 402 until the object 110 drops as programmed by the control system 120 to its sort destination as described in the next paragraph. As best shown in FIGS. 2-4, the lower loops 402 are elevated at a level below the induction line assemblies 200 and the upper loops 302, and above the sort destinations.

When directed by the control system 120, an object 110 will drop from its upper-loop cradle 304 to the pre-programmed lower-loop cradle 404. Each cradle 304, 404 comprises a bottom piece or floor 704, a gate piece 706, a pair of spaced-apart side pieces 720, 721, a cradle-gate cable 710, a cable arc 708, a manipulation piece 712, a manipulation piece guide 7,14, one or more cradle roller wheels 728, and may include a top piece 702. The cradle floor 704 is sandwiched between the spaced-apart side pieces 720, 721 and is slanted at about a 42 to 48 degree angle in the illustrative embodiment. A shallower or steeper floor incline, for example between about 30 and 60 degrees, could be used. The top piece 702 is connected to and spans each of the side pieces 720, 721 at the upper front portion of each cradle 304, 404. In any one upper loop cradle 304, its top piece 702 is generally slanted to substantially the same degree as the floor 704, and is generally aligned with the bottom portion of the floor 704 in the cradle 304 ahead of said first mentioned cradle 304. The maximum size object 110 that a cradle 304 may accommodate will be one that fits under the top piece 702 and between the side pieces 720, 721.

As noted, the upper-loop cradles 304 are oriented on the upper loop 302 in a forwardly facing direction as shown in FIGS. 2, 3 and 5, such that objects 110 drop out of the cradle 304 in the same direction as the cradle conveyor chain 716 moves. Each upper-loop cradle 304 has an open back portion 726 behind and below the floor 704. This configuration allows for minimal spacing between adjacent cradles 304 since each object 110 can slide out of the cradle 304 in which it is riding, passing underneath that cradle's top piece 702 and underneath and between, respectively, the floor 704 and spaced-apart sides 720, 721 of the cradle ahead of that cradle 304. The cradles 304 could also be configured without the open back portion 726; however, such configuration could require greater spacing between the cradles depending on the size of the objects 110 to be sorted.

The lower-loop cradles 404 are oriented on their loop 402 in an inwardly facing manner such that objects 110 drop to the inside of the loop 402 in a direction roughly perpendicular to the forward direction of travel of the respective conveyor chain 716. Because the sidewardly moving lower-loop cradles 404 do not drop their objects 110 toward adjacent cradles, they do not need an open back portion to obtain minimum spacing between cradles 404. Therefore, they may or may not have an open back portion, irrespective of the desired spacing between adjacent cradles 404.

The cradle gate 706 is movably connected to the floor 704 by a hinge (not shown) or other suitable device, and is generally perpendicular to the floor in the illustrative embodiment. One end of the grooved cradle arc 708 is connected to the underside of the gate 706, and the other end, which is loose, travels into a cavity 722 inside floor 704 when the cable 710 is pulled. The cable 710 is connected at one end to the underside of the gate 706 just above the cradle arc 708 and at the opposite end to the manipulation piece 714. The upper-loop cradles' 304 manipulation piece 714 protrudes outwardly through the side 720, and the lower-loop cradles' 404 manipulation piece 714 protrudes downwardly through the bottom of the cradle 404. The manipulation piece is disposed within the generally elongated cable guide 714 and is adapted to move back and forth along the guide's 714 length when actuated by the upper- or lower-loop pull rod 303, 403. The cradle roller wheels 728 are conventionally attached to the sides 720, 721 of the upper-loop cradles 304 and to the front and back sides of the lower-loop cradles 404.

The control system 120 will command an object 110 to drop from its lower cradle 404 to one of several sort destinations. The object may drop to one of the array of collection bins 501 in the collection bin assembly 500, to a loose-object conveyor 516, or to a lower-loop failed-to-drop conveyor 410. Each collection bin assembly 500 comprises a number of collection bins 501 arranged in double rows beneath and in the center of their respective lower loops 402 and over their respective conveyors 506, 526 as seen in FIGS. 2 and 3. Sandwiched between the double rows are walkways 602. Walkway 602 access to the bins 501 is provided by a door 504 in each bin. A system frame 604 supports the bins 501 and the sorting matrix. A collection-bin divider 502 divides the bins 501 into the double rows. A sack-conveyor bifurcator 508 divides the conveyors 506, 526 into two sides corresponding to the row of bins 501 over a particular side of the conveyors 506, 526. A number of sack-conveyor diverters 510 divert the sacks to one or more destination sack loading areas 512, 532. Objects 110 dropped, also referred to herein as diverted, to a collection bin 501 may thereafter, but need not be, placed in a sack 520 or otherwise grouped with other objects 110 sorted to the same collection bin 501. Alternatively, an object 110 may be diverted directly from its lower-loop cradle 404 down a loose-object slide 514 to the loose-object conveyor 516 for transport to a loose-object loading area 518 as shown in FIG. 4. At each sort destination 501, 518 the correct sorting of an object 110 may be confirmed by a comparative scan of the object's 110 label bar code and a unique bar code assigned to each collection bin 501 or loose-object loading area 518. Although only one loose-object loading area 518 and associated conveyor 516 is shown in FIG. 1, it is possible to have multiple loose-object loading areas 518 and associated conveyors 516 on the same side of the system and/or one or multiple mirror-image loose-object loading areas and associated conveyors on the other side of the system 100 opposite the area 518 and conveyor 516 shown.

After the take-away conveyors 506, 516, 526 have transported objects 110 to their specified loading areas 512, 518, 532, the objects 110 may be further processed according to a common processing characteristic. For example, sacks 520 of sorted objects 110 arriving at a single loading area 512, 532 from multiple collection bins 501 may be loaded onto the same truck for delivery.

The system 100 has a number of failed-to-drop conveyors 312, 410. Referring to FIGS. 2 and 3, it can be seen that an object 110 may be directed down failed-to-drop slide 311, or, as explained above, down recirculation slide 230, to conveyor 312. Similarly, an object 110 may be directed from its lower cradle 404 through drop point 408 for free fall to, or slide down a gravity slide (not shown) to, conveyor 410. Conveyor 312 runs under and generally perpendicular to the direction of travel of the upper loops 302 at the end of the upper-loop matrix 300 nearest to the induction line assembly 200. The conveyor 312 ultimately feeds into the lower-loop failed-to-drop conveyor 410. Lower-loop failed-to-drop conveyor 410 is disposed beneath and runs generally perpendicular to the travel of lower loops 402 and conveyor 312. Conveyor 410 transports the objects 110 deposited thereon to the recirculation conveyor 232 either for transport to the manual processing assembly 226 or for recirculation to the induction line assembly 200. In an alternative embodiment, conveyor 312 could bypass conveyor 410 and feed directly into recirculation conveyor 232. An additional lower-loop failed-to-drop conveyor 410 may be installed to permit diversion of failed-to-drop objects 110 along either side of the upper-loops assembly. In such case, the additional conveyor 410 located on the side of the upper-loop sort matrix 300 remote from the recirculation conveyor 232 could feed into the upper-loop failed-to-drop conveyor 312 for transport to conveyor 232, or a second recirculation conveyor 232 could be installed on the side of the upper-loop sort matrix 300 remote from the recirculation conveyor 232 depicted in FIG. 1.

In the illustrative embodiment, each of the surfaces on which objects 110 may slide, such as slides 230, 311, 514, chutes, cradle gates 706 and cradle floors 704, will be coated with a non-skid surface. The orientation of such surfaces will generally be on the order of about 42 to 48 degrees from horizontal, although shallower or steeper inclines/declines could be used. It should be noted that the elevated nature of the illustrative embodiment allows the invention to take advantage of gravity.

The operation of the system 100 is controlled by a digital control system 120, which directs the sorting and transfer process. The control system 120 comprises a-processing unit 125 and a number of sensor assemblies 130. The processing unit 125 receives input data from the sensor assemblies 130 associated with various conveyors, divert mechanisms, slides, chutes and sort destinations as previously described and as further described herein, and it outputs control signals instructing such devices to operate to sort and transfer objects 110 in a selected direction in order to arrive at their final sort destination 512, 518, 532.

Referring to FIG. 7, the control system 120 can be any conventional control system. In the illustrative embodiment, the control system 120 comprises a digital processor 125, such as a personal computer or a work station, connected to a plurality of input sensor assemblies 130 and to a number of output devices. As depicted in FIGS. 1 and 7, and as will be described, the illustrative embodiment utilizes the following sensors. Positional sensors 132 are used to confirm the position of objects at several points as they are moved, diverted or dropped. Scanners 134, 136 determine and confirm destination information for each object 110. One or more dimensioning sensors 138 determine the outer dimensions of each object 110. A scale or other weighing device 140 determines the weight of each object 140. Based on such input information, the control system 120 monitors and directs the movement of the conveyor belts and rollers, determines whether an object should be diverted and, if so, actuates the divert mechanisms, determines drop points and actuates the pull rods, directs workers in the loading of sorted sacks 520 and loose objects 110, and prints out reports and manifests.

Generally, each positional sensor 132 comprises a conventional photo-cell transmitter and receiver, though any detection advice could be used. The sensors 132 generally are placed such that the light path between the transmitter and receiver passes at a level slightly above the surface over which an object 110 passes between the transmitter and receiver at that location, and generally at a right angle from the direction of travel of such object 110. Such sensor assemblies 130 detect and report to the control system 120 the passage (or non-passage) of objects 110. The control unit 125 processes and applies such positional information as follows.

A sensor 132 placed in the holding area 206 warns of a backlog of objects 110 in that area. Sensors 132 in the pre-scan accumulation area 210 facilitate the accumulation and singulation of objects 110 for advancement into the scan zone 212. After an object 110 has been scanned for identification in the scan zone 212, a sensor 132 mounted at the discharge end of the scan zone 212 detects and reports to the control unit 125 the position of such object 110. Based on such positional information, together with similar positional information recorded for other objects 110 advancing single-file through the scan zone 212 of the same and other induction lines 202, the control system's 120 control unit 125 monitors the object 110's position along the remainder of the induction line assembly 200, without further scanning being necessary, by reference to the object 110's known sequential position along its respective induction line 202, 204. Based on such positional information, together with information about the object's 100 weight, size, destination and other characteristics determined when the object 110 passes through the scan zone 212, the control unit 125 either (1) diverts the object 110 from the induction line 202, 204 in the induction-line divert area 214; or (2) advances the object 110 along its induction line 202, 204, 236 to the induction-line discharge 240 and records the initial position of such object 110 upon its advancement into an upper-loop cradle 304.

As noted, the sensors 132 also facilitate accumulation and singulation of objects 110 along the induction line assemblies 200. In each portion of each induction line assembly 200, except the scan zone 212, sensors 132 are placed at appropriate intervals to detect gaps between objects 110 advancing along the induction line assembly 200. Such gaps typically result from either: (1) insufficiently frequent inductions of objects 110 at the induction-line intake 208; or (2) the downstream diversion of earlier-inducted objects 110 in the induction-line divert area 214. To prevent such gaps from diminishing throughput, such gaps are closed by accumulating objects 110 in single file at each of two points along each induction line 202, 204: (a) immediately before the intake end of the scan zone 212; and (b) immediately before the induction-line discharge 240. This accumulation is accomplished in a conventional manner in the illustrative embodiment by the coordinated use of multiple zones of conventional powered-roller conveyors. To facilitate the control system's 120 monitoring of each object's 110 position along the induction line assembly 200, accumulated objects 110 are simulated as they advance immediately past each of such two accumulation points, by use of a conventional singulation conveyor immediately downstream from each accumulation point. This singulation of objects 110 enables the control system 120 to distinguish a first object 110 from a second object 110 immediately behind such first object.

The control unit 125 from time to time determines that an object 110 must be diverted, as, for example, when an object 100 is determined to be too big or too heavy for the sorting matrixes 300, 400, or when the control system 120 is unable to plot a route to the object's 110 sort destination that will not result in a “location conflict” as described below. In such a case, sensors 132 mounted at each divert point. in the induction-line divert area 214 will confirm the passage of such a commanded divert object 110. So too, these sensors 132 will warn of the passage of any object 110 that was diverted not on command but in error.

As noted, objects 110 that are not diverted in the divert area 214 move along to the discharge 240, passing a sensor 132 prior to the discharge 240. Two other sensors 132 are mounted beneath the chute descending from the induction-line discharge 240 at opposite sides of each upper loop 302, to detect the advancement of such object 110 into an upper-loop cradle 304 positioned beneath such chute.

In the event of a location conflict resulting from the failure of an earlier object 110 to drop where programmed from its lower loop cradle to its final sort destination, which will be explained below, or an equipment malfunction, an object 110 may be directed by the control system not to drop, or may fail to drop, from its upper-loop cradle 304 to its pre-programmed lower-loop cradle 404. A sensor 132 is mounted at the drop point 310 on each upper loop 302, to detect the presence of an object 110 in an upper-loop cradle 304 positioned at such drop point 310. The control unit 125 will command such object 110 to drop to the failed-to-drop conveyor 312 at that drop point 310. One or more additional sensors 132 are mounted below each drop point 310 to detect the passage of such an object 110 down the chute 311 leading from such drop point 310 to the conveyor 312. An additional sensor assembly 130 is mounted at a point farther along each upper loop 302, between the drop point 310 and the upper-loop cradle 304 position immediately underneath the induction-line discharge 240, to confirm that each upper-loop cradle 304 passing by such sensor assembly 130 is unoccupied.

Sensor assemblies 130 are similarly used to confirm drops from the lower loops 402. First, a sensor 132 is mounted at each of drop point 408 and loose-object drop point 412 to detect passage of an object .110 to either the lower-loop failed-to-drop conveyor 410, or down the chute 514 to the loose-object conveyor 516, respectively. Second, a sensor 132 is mounted at the entrance to each collection bin 501 to confirm the passage of an object 110 into such collection bin 501.

Other sensor assemblies 130 include a number of scanners 134, 136, dimensioners 138, 140, and scales or other weighing devices 140. As will be described, an object will be scanned at the beginning and, optionally, at the end of its flow through the system 100. The initial scan will be accomplished by a conventional scanner 134 located in the scan area 212. Also in the scan area 212, each object 110 will be dimensioned by one or more dimensioning sensors 138 and weighed by a conventional scale or other weighing device 140. If an object's 110 sensed dimensions or weight disqualifies it from automatic processing by the system 100, or if its label information is determined to be unreadable, or if the object fails to meet other criteria programmed into the control system 120 (for example, the object is destined for an address to which no delivery will be made), then the control unit 125 will divert the object 110 as appropriate in the divert area 214. The final scan, optionally performed to confirm the correct sorting of an object 110, will be accomplished in the respective destination areas 501, 518 by another scanner 136. It will be appreciated that the control system 120 could utilize further sensors 132 throughout the system 100. For example, such sensors 132 could be used at the beginning and end of every conveyor, at the top and bottom of every slide or chute, at each destination, and at various intermediate positions along the way.

Referring now to FIGS. 1-8, the operation of the system 100 will be described in more detail. Objects 110 are inducted one by one, manually or automatically, at the induction-line intake 208 of each induction line 202, 204. Each inducted object 110 will have been pre-labeled with an object-identifying bar code or other optical code (not shown) that, upon scanning as described herein, can be linked to information previously transmitted to the control system 120 when the label was created. Such information will include at least the sort destination of the object 110 within the sorting system 100, but may also include other information about the object 110. An object 110 should be inducted in an orientation that will permit its bar code to be scanned automatically in the scan zone 212. For example, in one embodiment, the scanner 134 is a conventional overhead or in directional scanning device, which necessitates that each object 110 be inducted with its coded label facing upward in any horizontal direction.

In the pre-scan accumulation area 210 of each induction line 202, 204, inducted objects 110 are (1) arranged in single file along the induction line 202, 204, by using a conventional device such as skewed rollers or pop-up wheels to align all objects 110 to one side of the line 202, 204 so that the control system 120 can later record and monitor each object's 110 sequential position once it has been scanned in the scan zone 212 as described above; and (2) to accumulate objects 110 at the discharge end of the pre-scan accumulation area 210, immediately prior to the scan zone 212.

After inducted objects 110 have been accumulated single-file at the discharge end of the pre-scan accumulation area 210, they are simulated and advanced, one-by-one, into the scan zone 212, which comprises one or more segments of powered conveyor belts. As noted above, objects 110 are scanned, weighed and dimensioned in the scan zone 212 and then are advanced into the induction-line divert area 214. The scanner 134 may be either a conventional laser scanner or an over-thebelt video scanner having a charged coupled device (CCD) sensor. An example of the latter system is described in U.S. Pat. No. 5,308,960, which is incorporated herein by reference. The object's weight may be obtained by any conventional scale or other weighing device. For example, the weighing device 140 may be a conventional in motion scale, mounted under the conveyor belt in the scan zone 212, that is capable of weighing an object 110 as it passes through the scan zone 212. Any conventional dimensioning sensor assembly may be used to dimension the object 110. In one embodiment, dimensioning is accomplished by using a conventional CCD-based dimensioning system that is capable of determining all three dimensions of an object 110 as it moves through the scan zone 212. In another embodiment, dimensioning is accomplished by multiple arrays of photo-electric sensor assemblies 130 mounted alongside, above and/or below the scan zone 212 at intervals sufficiently close to measure each dimension with the accuracy required for the application involved.

Based on the information determined from the scanning, weighing and dimensioning of an object 110, the control system 120 determines whether such object 110 will be diverted away from the induction line 202, 204 in the induction line divert area 214 for recirculation, manual processing or other special handling. More specifically, if the object's 110 label code cannot be read, the object 110 will be diverted by a pop-up roller or other conventional diverter at the no-read divert 216 to the no-read conveyor 218 for re-scanning, and re-labeling if necessary, at the no-read processing area 220, after which it will be either recirculated to the induction line assembly 200 or manually transported to one of the sort destinations 501, 512, 518, 532. If the object 110 has dimensions or a weight that makes it unsuitable for automated sorting on the sorting matrices 300, 400, based on pre-set standards resident in the control unit 125, then the control unit 125 will direct that the object 110 be diverted at the manual-processing divert 222 to the manual processing conveyor 224 for manual processing in the manual processing area 226, after which it will be manually transported to its sort destination 501, 512, 518, 532. Optionally, additional or different diverts can be installed in the induction-line divert area 214 to route such unsuitable objects 110 directly to one or more loose-object loading areas 518, without any intermediate manual processing or transportation.

Each object 110 will have four opportunities to drop, drop points 800, from the object's 110 upper-loop cradle 304 to a lower cradle 404 on the lower loop 402 that sorts to the object's 110 sort destination. Two such opportunities occur on the outgoing run, and two such opportunities occur on the return run, of the upper cradle 304 which the object 110 is occupying. If more than one lower loop 402 sorts to the final sort destination of the object 110 in question, then such object 110 will have an additional four drop opportunities per such loop 402. For example, in the embodiment depicted in FIG. 1, there are two lower loops 402. If an object 110 were addressed to a certain zip code, and the collection bin 501 for that zip code were fed by both lower loops 402 (such configuration not being shown in FIG. 1), then the object would have eight drop opportunities to reach a bin destined for that zip code, four from each of such two lower loops 402.

A “location conflict” will exist if, but only if, the control system 120 is unable to plan an unobstructed route for an object 110 through the sorting matrices 300, 400 because all four (or more) of the object's 110 drop opportunities 800 predictably will be unavailable when the object 110 arrives there. This will be the case only if each of the lower cradles 404 predicted to be present beneath each of such drop points 800 will then be occupied by an earlier object 110. If a location conflict exists, then the control system 120 will direct that the object 110 be diverted at the recirculation divert 228, after which it will proceed down the recirculation slide 230 leading to the upper failed-to-drop conveyor 312, and then to the recirculation conveyor 232. The object 110 will then be recirculated for re-induction onto an induction line assembly 202, 204, or instead may be diverted at the recirculation divert to the manual processing area 226 for manual processing and transport to one of the sort destinations 501, 512, 518, 532 as directed by the control system after such object 110 has been re-scanned at such area 226.

The control system 120 uses the following information to determine whether an object I 10 can be routed to its sort destination without a location conflict, all of which information will be known to, or determinable by, the control system 120 once the object 110 has been scanned, weighed and dimensioned in the scan zone 212. For simplicity, it is assumed in the explanation below that the object 110 in question has four drop opportunities from its upper-loop cradle 304 to the lower loop 302 that feeds its final sort destination:

A. The object's 110 sort destination, which will be either a collection bin 501 or a drop point to a loose-object conveyor 412, and the specific lower loop 402 serving that sort destination, referred to hereinafter as the “target lower loop” 402.

B. The number of system steps 50 that will be required for the object 1 10 to reach each of the four drop opportunities 800 to its target lower loop 402. This number of system steps is calculated by the control system 120 based on the following data:

1. The number of other non-diverted objects 110 ahead of the present object 110 on the same induction line 202, 204, which will determine the number of steps 50 required for the present object 110 to arrive at the induction-line discharge 240. In the case of a bifurcated induction line 204, the control system 120 may adjust this number of steps 50 if necessary to prevent a location conflict, as further explained below, by altering the subsequent distribution of objects 110 between the two forks of such bifurcated induction line 204; and

2. The number of system steps 50 that will be required for the present object 110 to reach each of its four drop opportunities 800 after the object 110 has advanced into its upper-loop cradle 304.

C. The predictable presence of an earlier-routed object 110 in the lower-loop cradle 404 beneath one or more of the object's 110 four drop opportunities 800 when the present object 110 arrives there, referred to hereinafter as a “blocking object” 110. To predict the presence of a blocking object 110, the control system 120 takes into account the route previously planned for each earlier object 110, including not only earlier objects 110 that are already in lower-loop cradles 404, but also earlier objects 110 that are still in upper-loop cradles 304 or on induction lines 202, 204.

If the control system 120 initially determines that only one of the present object's 110 four drop opportunities 800 will be available, then the control system 120 generally will program the object 110 to drop at that drop opportunity 800. If two, three or four drop opportunities 800 instead will be available to the object 110, then the control system 120 will choose among such drop opportunities 800 based on pre-established criteria resident in the control system 120. These criteria may include, for example, the directness of the route from each drop opportunity 800 to the object's 110 sort destination, the relative probability of location conflicts with later objects 110 posed by each alternate route (which probability may be based on, among other information, the control system's 120 analysis of historical data concerning the distribution of earlier objects 110 among sort destinations), and the advantage of maintaining flexibility to reroute the object 110 later, for reasons described below, which may result, for example, in the object 110 being assigned to drop at the first of such two, three or four drop opportunities 800 even if a later drop opportunity 800 presents a more direct route.

If the control system 120 initially determines that a location conflict will exist for the present object 110, i.e., that a blocking object 110 will be occupying the lower-loop cradle 404 beneath each of the four drop opportunities 800, then the control system 120 nevertheless may be able to avoid such location conflict by rerouting an earlier-routed object 110. The earlier-routed objects 110 considered for such rerouting will include each of the four blocking objects 110, but may, if necessary, include additional earlier-routed objects 110, as necessary. For example, the control system 120 may evaluate each of the following rerouting opportunities, among others:

1. If any one of the four blocking objects 110 has not yet reached its lower-loop cradle 404, and at least one alternate drop opportunity 800 remains available to that blocking object 110, the control system 120 can reprogram that blocking object 110 to drop to its target lower loop 400 at a different drop opportunity 800, thus creating a drop opportunity 800 for the present object 110. p1 2. If only its originally programmed drop opportunity 800 remains available to each of the four blocking objects 110, but one or more of those blocking objects 110 has not yet advanced beyond all of its blocked drop opportunities 800, then the control system 120 may be able to “unblock” one or more of the blocked drop opportunities 800 for such blocking object 110 by rerouting one of the objects 110 that would otherwise have blocked that blocking object 110.

3. If the sorting system 100 includes one or more bifurcated induction lines 204, additional rerouting opportunities are available to the control system 120, even if the present object 110 itself is on a non-bifurcated induction line 202. For example, if the present object 110 is on a bifurcated induction line 204, the control system 120 can initially route the object 110 to either of the two upper loops 302 fed by such bifurcated line 204, effectively making eight, rather than four, drop opportunities 800 available for-the present object 110. If the present object 110 instead is on a non-bifurcated induction line 202, but one or more blocking objects 110 are on a bifurcated induction line 204, then the control system 120 may be able to reroute such a blocking object 110 to a drop opportunity 800 on the other fork 236 of such bifurcated induction line 204 if the blocking object 110 has not yet reached the fork 236 on its induction line 204.

4. In addition to these rerouting opportunities, the control system 120 may be programmed to override an earlier object 110 routing even if no alternate route can be plotted for that earlier object 110. Such a rerouting may be desirable, for example, if the present object 110 needs to be sorted promptly but the blocking object 110 need not be sorted as promptly. In that event, the earlier blocking object 110 will be reprogrammed to remain in its upper-loop cradle 304 and to drop to the upper failed-to-drop conveyor 312 at the end of its circuit around its upper loop 300.

Thus, the crossing-loops configuration of the sorting system 100 reduces the possibility of location conflicts by creating at least four drop opportunities 800 from each upper loop 302. The statistical possibility of an incurable location conflict depends on several factors in addition to those previously described, principally including the number of lower loops 402, the number of upper loops 302, and the extent to which objects 110 are disproportionately routed among the lower loops 402. Although this statistical possibility may be extremely low in some sorting system 100 configurations, and may be further reduced by rerouting methods including but not limited to those described above, the theoretical possibility of an incurable location conflict cannot be entirely eliminated. For this reason, the sorting system 100 must provide for some method of diverting objects 110 for which an incurable location conflict exists.

As described above, one such diverting method, which is shown in the illustrative embodiment depicted in FIG. 1, is to divert an object 110 from its induction line 202, 204 before it reaches its upper loop 302, and to reduce or prevent any diminution in throughput by closing the resulting gap in object 110 flow by the accumulation methods described above. An alternate method, not further explained herein, would be simply to advance each “location conflict” object 110 into an upper loop cradle 304 without first determining whether a location conflict will exist when the object 110 arrives at each of its four drop opportunities 800, and then to use sensor assemblies 130 to detect the presence or absence of an earlier object 110 beneath each of such four drop opportunities 800 when the present object 110 arrives there. Under such alternate method, any object 110 that is blocked at all four drop opportunities 800 would be routed to the drop point 310 to conveyor 312 on its upper loop 302, and then be recirculated or manually processed as described above.

If the control system 120 is able to plot an unobstructed route for an object 110 as just described, the object 110 will continue through the post-divert accumulation area 238, which begins at the discharge end of the scan zone 212 (and thus includes the divert area 214) and ends at the induction-line discharge 240. The post-divert accumulation area 238 is devoted to the accumulation of non-diverted objects 110 at the induction-line discharge 240, while maintaining the objects' 110 single-file sequence. Gaps in object 110 flow will have been created by the diversion of objects 110 in the divert area 214. On a bifurcated induction line 204, which feeds two upper loops 302, the control system 120 causes objects 110 to be distributed to each fork of the bifurcated induction line 204. This may be accomplished by the use of conventional divert devices such as subsurface pop-up wheels mounted between rollers on the powered-roller conveyor. As mentioned above, the control system 120 may adjust the distribution of objects 110 between the forks on a bifurcated induction line 204 if necessary to resolve a location conflict. For example, if objects are generally alternated between the two forks 236, the control system 120 may direct instead that two successive objects 110 be directed to the same fork 236 in order to avoid a location conflict that would otherwise exist for the second object 110. As noted, the sorting system 100 can accommodate trifurcation or even further division of a single induction line 200, provided only that (1) the control system 120 is able to monitor the sequential position of all objects 110 as they are distributed among the multiple forks 236; and (2) objects 110 can be advanced quickly enough to ensure that an object 110 reaches the induction-line discharge 240 at each fork 236 by the beginning of each system step 50.

The objects 110 proceed from the post-divert area 238 to the induction-line discharge 240. The objects 110 are accumulated at the induction-line discharge 240 and are then simulated and advanced, one at a time, into one of the stationary upper-loop cradles 304. Only one object 110 occupies any one upper-loop cradle 304 at a time. One object 110 is advanced in this manner from each induction line 202, 204 during the stationary substep 56 of each system step 50. The timing of system steps, and of the stationary substep 56 and the move substep 55, is described further below. Thus, the cradles 304 are not moving when objects 110 are deposited therein. The object's 110 target cradle 304 will have been moved into position during the preceding move substep 55. In the preferred embodiment shown in the drawings (see FIGS. 2-4), the object 110 is first advanced past the induction-line discharge 240, then down a gravity slide, and finally onto the slanted cradle floor 704, where its motion is stopped by the cradle gate 706. In the preferred embodiment, the gate 705 protrudes outwardly from the slanted floor of the upper-loop cradle 304 at approximately a right angle. It is movably attached to the upper-loop cradle 304 by a hinge 709 (not shown) on the bottom edge of the gate 706. This hinged attachment permits the gate 706 later to be pulled down during a stationary substep 56, as described below, so that the cradle floor 704 and the lowered gate 706 form a continuous slanted surface leading from the top to the bottom of the cradle 304, thus enabling an object 110 to slide down into a lower-loop cradle 404 as described below. Unless the cradle gate 706 is pulled down, its “default” up position is maintained either by some bias such as spring-loading or by a latch mechanism (not shown), with sufficient resistance to stop the motion of an object 110 sliding into the cradle 304. Each cradle's 304, 404 side pieces 720, 721 prevent an object 110 from escaping at either side of the cradle 304, 404. If the cradle 304 includes a top piece 702, such top piece 702 will prevent the object 110 from passing over the cradle gate 706 as the object 110 drops into its upper-loop cradle 304, and such top piece 702 will later ensure that the object 110 does not contact the cradle 304 ahead of it when the object 110 drops into a lower-loop cradle 404.

The cradles 304, 404 are carried on their respective sorting loops 302, 402. As previously described above, the illustrative sorting matrices 300, 400 comprise three horizontal, longitudinally extending, closed-oval sorting loops 302 elevated above two horizontal, transversely extending, closed-oval sorting loops 402. On each matrix 300, 400 level, cradles 304, 404 are attached to the conveyor chain 716 by conventional attachments 718. It will be appreciated that a power-driven cable, shaft or other mechanism instead of the power-driven chain 716 may be used to drive the cradles 304, 404 around the loops 302, 402. On both loop levels 300, 400, the cradles 304, 404 are attached to the conveyor chain 716 at intervals around their respective loops 302, 402. The interval between each cradle 304 on an upper loop will be the same distance (or an exact multiple of such distance), and the interval between each cradle 404 on a lower loop will likewise be the same distance (or an exact multiple of such distance). Generally the interval between cradles 304 on each upper loop 302 will be the same, and the interval between cradles 404 on each lower loop 402 will be the same. The uniform interval between upper-loop cradles, 304 need not be the same, however, as the uniform interval between lower-loop cradles 404. The system 100 will operate equally well regardless of the interval between cradles 304, 404, as long as (1) the interval between any two cradles 304, 404 on a given loop 302, 402, is the same distance (or an exact multiple of such distance), and (2) in the case of upper loops 302, the interval between the upper cradles 304 is not so close as to obstruct an object's drop. By way of example only, the interval between all cradles 304 on the upper loops 302 might be about 48 inches (1.2 m), and the interval between all cradles 404 on the lower loops 402 might be about 30 inches (76 cm). Similarly, the cradles 304, 404 may be of almost any size, depending on the maximum size of the objects 110 to be sorted.

In the illustrative embodiment depicted in the drawings, each cradle's 304, 404 weight is supported by roller wheels 728 attached to the cradles 304, 404, though other methods of supporting and guiding the cradles, such as a rail system, can instead be used. As has been explained, the front, or open side, of each upper-loop cradle 304 faces in the direction of travel of the upper loop 302, and an object 1 10 dropping from its cradle 304,to a lower-loop cradle 404 drops through an aperture 307 in the upper-loop floor 306 located in front of the upper-loop cradle 304. In contrast, the open side, or front, of each lower-loop cradle 404 faces toward the inside of the ellipse formed by the lower loop 402, which is perpendicular to the direction of travel of the lower loops 402, and each object 110 dropping from its lower-loop cradle 404 to a collection bin 501 or a drop point 412 passes in such inward direction.

Each upper loop 302 and each lower loop 402 circulates in timed system steps 50. Each step 50 comprises a move substep 55 and a stationary substep 56. The time-length of each system step 50 is the same on both loops 302, 402, and will have been pre-set by the control system 120 based principally on the length of time determined to be necessary for each of the two sub steps 55, 56 to be reliably completed.

During the move substep 55, the cradles 304, 404 advance around their respective loops 302, 402 by a distance equal to the spacing between the cradles 304, 404 on such loop 302, 402. During the stationary substep 56, the cradles 304, 404 remain stationary. If, however, a cradle 304,404 contains an object 110 that has been programmed to drop at that stationary location, then its cradle gate 706 will be pulled down (as described in detail below) at the beginning of the stationary substep 56 and will be maintained in such down position long enough for the object 110 to slide out of its cradle 304, 404. The gate 706 will then be released to return to its default up position.

As noted, the duration of a system step 50 is the same on both loop matrices 300, 400. This duration need not, however, be allocated equally between the two sub steps 55, 56, and the time allocation between sub steps 55, 56 may be different on each of the two loop matrices 300, 400. Nor is it necessary that a step 50 begin at exactly the same moment on each loop matrix 300, 400. Nevertheless, it is necessary that steps 50 on both matrices 300, 400 be synchronized sufficiently that a lower-loop cradle 404 is stationary beneath a drop opportunity 800 whenever an object 110 may be dropping from its upper-loop cradle 304 into such lower-loop cradle 404. In a typical embodiment of the system 100, this will require that sub steps 55, 56 on each loop 302, 402 be of approximately the same duration, and that system steps 50 begin at approximately the same time on each loop 302, 402, or slightly later on the lower loops 402 than on the upper loops 302. While any one substep 55, 56 may be completed early, the succeeding substep 55, 56 may never begin early.

By way of example only, the duration of the system step 50 in the preferred embodiment may be on the order of five seconds, with approximately onehalf of such duration being allocated to each substep 55, 56. As noted above, however, a system step 50 may be of any duration, and that duration may be allocated in any manner between the move substep 55 and the stationary substep 56 (and may be allocated differently between such two sub steps on each of the two sorting matrices 300, 400), provided only that the system step 50 duration is the same on both sorting matrices 300, 400 and that sufficient time is allocated to each system step 50, and to each substep 55, 56, to accomplish the actions required to be taken during each such step 50 and substep 55, 56.

Thus it can be seen that the system 100 operates in steps 50 of defined duration, and, in the case of the move substep 55, defined duration and distance of movement, which enables the control system 120 to predict the location of each object 110 at each future step 50 as the object 110 moves through the system 100. Although the system 100 generally will operate with all upper loops 302 and lower loops 402 advancing during each system step 50, the system 100 can operate normally if one or more upper loops 302 and/or one or more lower loops 402 either remain stationary during a move substep 55 or are entirely disengaged from the operation of the remainder of the sorting system 100, provided in each case that the control system 120 records such non-movement of such loop 302, 402 and reroutes objects 110 as may thereby become necessary.

As noted, objects 110 will drop from upper cradles 304 to lower cradles 404 during a stationary substep 56. In the preferred embodiment illustrated in the drawings, such transfer of an object 110 as programmed by the control system 120 is accomplished by lowering the cradle gate 706 of the cradle 304 to create a gravity slide leading to the target lower-loop cradle 404. Because this drop occurs during a stationary substep 56, the cradles 304, 404 and their associated loops 302, 402 will remain stationary while each such object 110 is dropping out of the one or more of upper-loop cradles 304 and into the one or more target lower-loop cradles 404.

As illustrated in FIGS. 2, 3, and 5, the slide thus created comprises (1) the cradle floor 704; (2) the cradle gate 706; and (3) the respective upper-loop drop slide 308, which is incorporated into the system frame 604 beneath the upper loop floor 306 and which extends downwardly toward the target lower-loop cradle 404. In sliding down the slide 308, the object will follow one of two slide paths, depending on the orientation of the cradles 304, 404 at the time of the particular drop. A first slide path 812 is defined by an object 110 sliding down the slide 308 and continuing its slide down the cradle floor 704 of the target lower-loop cradle 404. When following this slide path 812, the motion of the sliding object 110 is stopped by the cradle-gate 706 of the target lower-loop cradle 404. A second slide path 814 is defined by an object 110 sliding down the slide 308 and continuing its slide down the cradle gate 706 of the target lower-loop cradle 404, in which case the motion of the sliding object 110 is stopped by the cradle floor 704 of the target lower-loop cradle 404. Although the illustrative system 100 configuration thus permits two slide paths 812, 814, a system 100 may instead be configured to include only one or the other of such two slide paths 812, 814.

In the illustrative embodiment shown in FIG. 5, an object 110 drops from its upper-loop cradle 304 to its target lower-loop cradle 404 (not shown in FIG. 5) immediately after the cradle gate 706 of the cradle 304 is pulled down during a stationary substep 56. The cradle gate 706 is pulled down by the cradle-gate cable 710 attached to the bottom of the gate 706. The cable 710 passes through an aperture (not shown) in the floor 704 and attaches at its other end to the rigid manipulation piece 712 that protrudes from the side 720 of the upper-loop cradle 304. During each stationary substep 56, the manipulation piece 712 of each upper-loop cradle 304 positioned above a drop opportunity 800 will be positioned directly opposite a manipulation-piece puller (not shown) attached to the pull rod 303 mechanism, which mechanism 303 is supported by the frame 604 and driven by a motor and associated gearing (not shown).In the illustrative embodiment shown in FIG. 5, the puller is a pneumatically-powered device by a solenoid valve (not shown) that is controlled, in turn, by a signal received from the control system 120. Any other type of connection between the cradle gate 706 and the manipulation piece (in lieu of the cable 710 illustrated in FIG. 5), manipulation piece, actuator and/or puller device may instead be used, provided only that, when used in combination, they cause the cradle gate 706 to be pulled down in response to one or more signals received from the control system 120, thus enabling an object 110 in such cradle 304, 404 to slide down and out of such cradle 304, 404 as programmed by the control system 120.

In response to a signal from the control system 120, the solenoid (not shown), or other actuating mechanism will move the puller so that it engages the manipulation piece 712 as the motor and associated gearing (not shown) are moving the pull rod 303 forwardly far enough that the cradle-gate cable 710 will pull down the cradle gate 706, thus enabling the object 110 to slide down and out of the cradle 304, through an upper-loop floor aperture 307, onto the slide 308, and finally into its target lower-loop cradle 404. In FIG. 5, the manipulation piece 712, when pulled, will move within its cable guide 714 in the direction that the cradle 302 has been moving. It is possible, however, for the piece 712 to move in the opposite direction, or in any other direction, in an alternate embodiment, provided only that the manipulation piece is moved a sufficient distance to cause the cable 710 to pull down the gate 706. After the object 110 has dropped to its target cradle 404, the puller will retract, thereby releasing the manipulation piece 712 and allowing the spring-loaded cradle gate 706 to return to its default “up” position, thus returning the manipulation piece 712 to its original position as well. In FIG. 5, retraction of the manipulation piece 712 will also occur as the result of the cradle 304 advancing during the next move substep, as the manipulation piece 712 will move away from the puller when this advancement occurs. All drops from a cradle 304, 404 will occur substantially as just described, with some differences in drops from lower-loop cradles 403 as will be described.

As described above, an object 110 typically will have been diverted in the induction-line divert area 214 if an incurable location conflict prevented the control system 120 from plotting an unobstructed route to the object's 100 sort destination 501, 518. For this reason, an object 110 in an upper-loop cradle 304 ordinarily will have dropped to a lower-loop cradle 404 before it reaches the drop point 310 to the upper-failed-to-drop conveyor 312. That drop point 310 is located beyond all viable drop opportunities 800 on an upper loop 302. An object 110 that has failed, for any reason, to drop out of its upper-loop cradle 304 before reaching that drop point 310 will be commanded by the control system 120 to drop there 310, during a stationary substep 56. As described above, possible reasons for such a required drop to the failed-to-drop conveyor 312 include instances where (1) the object 110 has failed to drop from its upper-loop cradle 304 for some unprogrammed reason, such as a mechanical failure; (2) the control system 120 has determined that the object's 110 planned route will be blocked by the failure of an earlier object 110 to drop as programmed from its lower-loop cradle 404 to its sort destination; or (3) the control system 120 has rerouted such object 110 to drop at such drop point 310 to permit a later object 110 to be routed through the sorting system 100 because the later object 110 is required to be sorted more promptly. There may be additional reasons for such a drop.

As illustrated in FIG. 1, each induction line discharge 240 is located near the end of the upper loops 300 matrix nearest to the induction line assembly 200 illustrated in FIG. 1, and the upper failed-to-drop conveyor 312 is located outside of the periphery of the lower loops matrix 400 nearest to the induction line assembly 200. A system 100 may instead be configured such that part or all of the induction line assembly 200 is positioned above the sorting matrices 300, 400, with each induction line discharge 240 thus being positioned farther forward over the sorting matrices 300, 400 rather than at or near their periphery as shown in FIG. 1. In such an alternative configuration, because the upper failed-to-drop conveyor 312 will ordinarily occupy substantially the same position relative to the induction line discharge 240, the upper failed-to-drop conveyor 312 would also be positioned farther forward in the area of the sorting matrices 300, 400, rather than at or near their periphery. For example, the upper failed-to-drop conveyor 312 in such an alternative configuration might be located above one of the walkways 602, described below, sandwiched between, and running parallel to, two adjacent double-rows of collection bins 501. Similarly, although in the illustrative example in FIG. 1 the lower loop failed-to-drop conveyor 410, described below, is located outside the periphery of the upper loops sorting matrix 300, a system 100 may instead be configured with the lower loop failed-to-drop conveyor 410 located within the periphery of the upper loops sorting matrix 300. For example, the lower loop failed-to-drop conveyor 410 could be located above the walkway 600, described below, which separates the two sides of the collection bin 501 assembly.

The drop of an object 110 from its upper-loop cradle 304 at a drop point 310 will occur as follows. Sensor assemblies 130 are positioned at the drop point 310, along the upper-loop fail-to-drop slide 311, and at one or more points along the upper loop 302 after the drop point 310 and prior to the induction-line discharge 240 of the associated induction line 202, 204. These sensor assemblies 130 detect the presence, and confirm the drop, of each object 110 that reaches such drop point 310, thus enabling the control system 120 to monitor the location of such object 110 and ensuring that each upper-loop cradle 304 arriving beneath the induction-line discharge 240 of the associated induction line 202, 204 is unoccupied so that a new object 110 can be advanced into such upper-loop cradle 304. Each drop of an object 110 at a drop point 310 is accomplished in the same manner as described above for a drop occurring at a drop point 800. Sensors 132 will confirm the drop of such failed-to-drop object 110 onto the drop slide 311 leading to the upper failed-to-drop conveyor 312. The drop will be further verified by upper-loop sensors 132 located along the upper loop 302 downstream of the drop point 310 but prior to the discharge 240 feeding such loop 302. Once the object 110 has reached the failed-to-drop conveyor 312, it will be advanced to the recirculation conveyor 232 for recirculation to the induction line assembly 200 or manual processing.

If the control system 120 determines that an upper-loop cradle 304 is occupied when it arrives beneath the induction-line discharge 240, then the control system 120 will shut down that particular induction line 202, 204 for one system step 50 to prevent the next new object 110 in line from dropping into the still-occupied upper-loop cradle 304. At the next system step 50 after the induction line 202, 204 shut-down, the still-occupied upper-loop cradle 304 will have advanced one position beyond the induction-line discharge 240 and an unoccupied cradle 304 should be positioned below the discharge 240 such that the induction line assembly 202 may be restarted. The failed-to-drop object 110 may then be reprogrammed to drop at one of the potential drop opportunities 800 on its second circuit around the upper loop 302. If the object 110 fails to drop as programmed on its second circuit around the upper loop 302 (for example, because its failure to drop has resulted from a mechanical malfunction or because the object has become jammed or is otherwise unable to slide freely out of its cradle 304), then it may be manually removed. It may be necessary that the upper loop 300 be stopped to permit such manual removal. In each event requiring a shut-down of the upper loop 300, the control system 120 will adjust the routing of objects 110 on the affected upper loop 302 as necessary.

Similarly, each lower loop 402 has one or more drop points 408 to the lower failed-to-drop conveyor 410 from which an object 110 may be programmed to drop if it has passed its predetermined sort destination without dropping as programmed from its lower-loop cradle 404. A sensor assembly 130 positioned at the entrance to each sort destination 501, 518, 532 will detect and report to the control system 120 each drop of an object 110 to that sort destination. If the control system 120 fails to receive a report of a programmed drop to a sort destination, then the control system 120 will (1) reroute the failed-to-drop object 110 to the nearest drop point 408 to the lower failed-to-drop conveyor 410, which in turn will convey the object 110 to the recirculation conveyor 232; and (2) reroute any later object 110 for which an unanticipated location conflict has been created by the failed-to-drop object 110. It should be noted that an object's 110 failure to drop where programmed from its lower-loop cradle 404 can create a location conflict only for a later object 110 that has not yet reached its own lower-loop cradle 404; i.e., an object 110 that is still in its upper-loop cradle 304 or on its induction line 202, 204. If an unobstructed alternate route cannot be plotted for such a later object 110, then the control system 120 will instead reprogram that later object 110 to remain in its upper-loop cradle 304 until it has reached the drop point 310 to the upper failed-to-drop conveyor 312, where the object 110 will drop for recirculation or manual processing as described above.

If the sorting system 100 is not malfunctioning, it will ordinarily never be necessary to reroute an object 110 to the lower failed-to-drop conveyor 410. The control system 120 may, however, employ sensor assemblies mounted at the entrance to each collection bin 501 or drop point 412 to a loose-object slide 514 to detect a “full” condition (or other obstruction) at such entrance, in which event the control system 120 may reroute an object 110 destined for such sort destination to the lower failed-to-drop conveyor 410. For either or both of such reasons, the sorting system 100 normally will include at least one such drop point 408 to the lower failed-to-drop conveyor 410, and may include multiple drop points 408—for example, one at each side of the lower loops 402—to remove objects 110 which have not dropped where programmed from the lower loops 402.

As described above, an object 110 may be routed to the recirculation conveyor 232 from one of three sources: the induction-line divert area 214, any upper-loop cradle 304, or any lower-loop cradle 404. Objects 110 that reach the recirculation conveyor 232 ordinarily are recirculated, without further manual handling, back to the pre-induction holding area 206 for re-induction. Optionally, as previously stated, the control unit 125 may position the recirculation divert 234 to divert such objects 110 from the recirculation conveyor 232 into the manual processing area 226 for re-scanning and manual transportation to their respective sort destinations. This may be done, for example, near the end of a sort, when the final objects 110 passing along the recirculation conveyor 232 are likely to reach their sort destinations more quickly if manually processed.

More typically, though, objects 110 will arrive at their sort destinations as follows. An object 110 that drops as programmed into its target lower-loop cradle 404 will proceed in system steps 50 around its lower loop 402 until it reaches its programmed sort destination, which will be either one of the collection bins 501 or one of the drop points 412 to a loose-object slide 514, as depicted in FIG. 4, for delivery to the loose-object holding area 518 as will be described.

The object 110 will drop into its sort destination 501, 412 during a stationary substep 56. If the object 110 fails to drop where programmed, it will be rerouted by the control system 120, as described above, to drop instead at a drop point 408 to the lower failed-to-drop conveyor 410, where it will be routed to the recirculation conveyor 232 for re-induction or diversion to the manual processing area.

In the illustrative embodiments depicted in the drawings, a drop from a lower-loop cradle 404 to its sort destination is accomplished in the same manner as described above for the drops of an object 110 from an upper-loop cradle 304 to a lower-loop cradle 404, except that, because of the inward-facing orientation of cradles 404 on the lower loops 302 (1) an object 110 drops inwardly in a direction perpendicular to the direction of travel of the lower loop 402; and (2) the cradle-gate manipulation piece 712 protrudes from the bottom or from the back of each lower-loop cradle 404, rather than from the side as on an upper-loop cradle 304, and the associated pulling mechanisms are accordingly positioned beneath or behind the lower-loop cradles 404.

An object 110 that drops from its lower-loop cradle 404 to a loose-object conveyor(s) 516 will be conveyed to a loose-object holding area 518. As noted, the invention will accommodate additional loose object conveyors 516 and associated loose-object holding areas 518. For example, a mirror-image loose-object area assembly could be added to the opposite side of the illustrative system 100. Also, since commercial embodiments likely will have a greater number of upper and lower loops 302, 402, there will be a corresponding increase in the possible number of loose-object area assemblies.

An object 110 that drops instead to a collection bin 501 generally will be manually removed from the collection bin 501, then grouped, as for example in a sack 520, with one or more other objects 110 that have been sorted to the same collection bin 501, and then transported in such grouping to a sack loading area 512, 532, either manually or by placing such a sack 520 onto one of the sack conveyors 506, 526 leading to such sack loading area 512, 532. The correct sortation of an object 110 to its sort destination may be confirmed by a re-scanning of the object's label-code 110 once it has reached a collection bin 501 or a loose-object loading area 518. Such re-scanning will be accomplished by a scanner 136, which may be a handheld manual scanner or a mounted automatic scanner.

Such a mounted or hand-held scanner 136 may also be used to scan sacks at any of a number of locations. In the illustrative embodiments in the drawings, FIGS. 1-4, each sack conveyor 506, 526 is functionally bifurcated by a sack-conveyor bifurcator 508 suspended from the system frame 604 above the sack conveyor 506, 526. This bifurcation enables a single sack conveyor 506, 526 to serve two adjacent rows of collection bins 501 destined for two different respective sack loading areas 512, 532. A sack-conveyor diverter 510, 530 positioned near the end of each bifurcated portion of such a respective sack conveyor 506, 526 diverts sacks 520 to the correct sack loading area 512, 532. Each sack 520 will have been labeled to identify the collection bin 501 from which it has been filled, to distinguish it from other sacks 520, if any, that may be routed to the same sack loading area 512, 532 from other collection bins 500. The correct routing of such sacks 520 may be confirmed by scanners 136 if the sack 520 labels include optically-readable code, or instead by visual inspection.

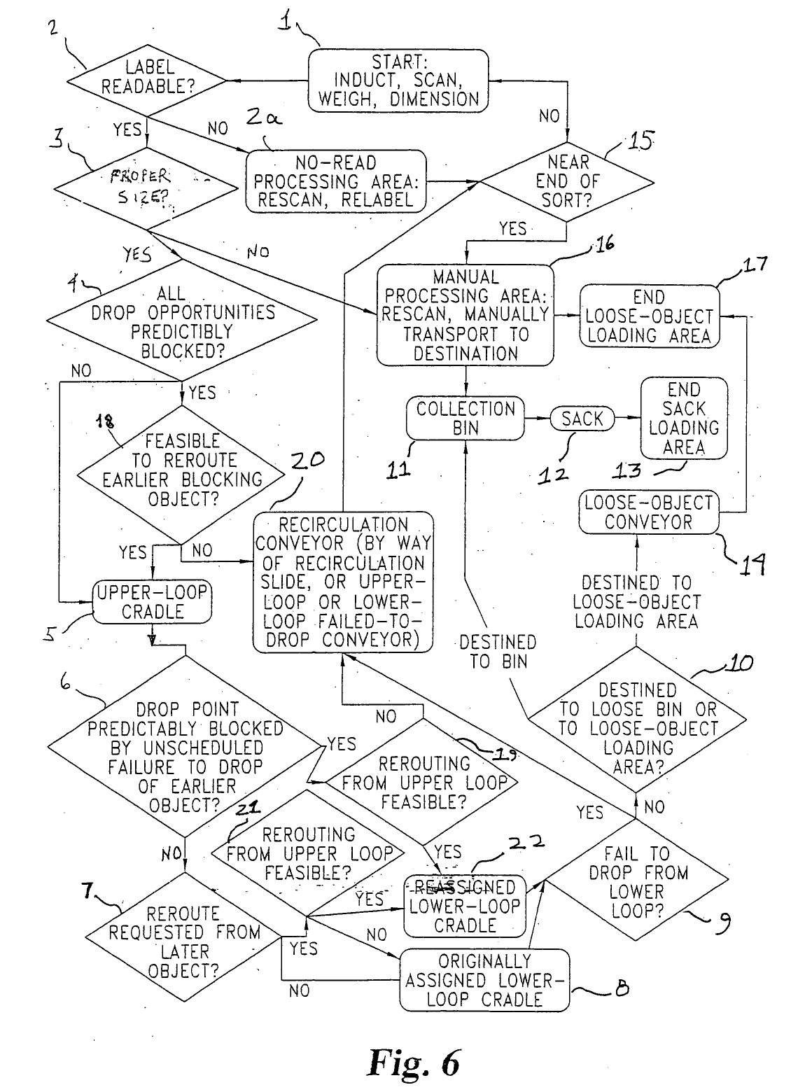

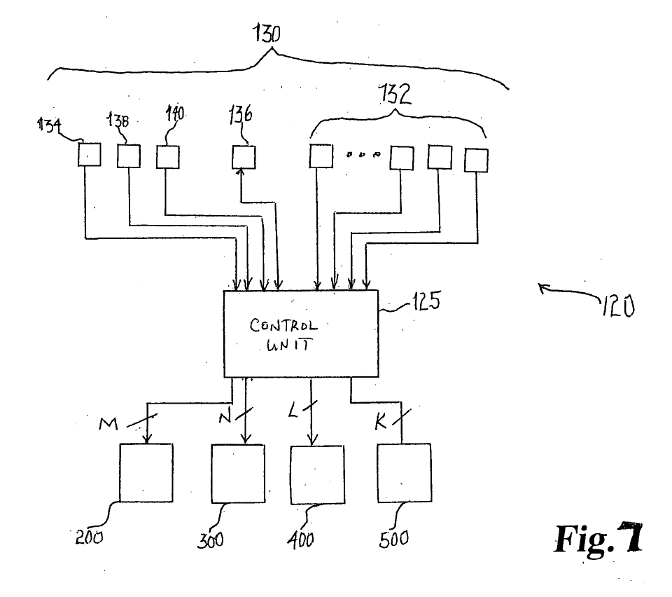

As previously described in detail, the control system 120 monitors the status of the objects 110 from induction to discharge using logic circuitry. The general configuration of the control system 120 and its attendant logic functions can be summarized with reference to FIGS. 6 and 7. At step 1, each object 110 is inducted at the induction line assembly 200 and scanned, weighed and dimensioned in the scan zone 212 of said assembly 200. If the scanner 134 can read the object's 110 label at step 2, and if the weight or the dimensions of the object 110 are not out of automatic processing parameters at step 3, then the control unit 125 will project at step 4 whether all of the drop opportunities will be predictably blocked. If a drop opportunity can be found at step four, then the control unit will advance the object to the next cradle 303 on the upper loop 304 at step 5. If at step 6 the control unit 125 does not predict any unscheduled failures of any earlier object 110 to drop, and if at step 7 the control unit has not elevated over the present object's 110 priority the priority of any later object 110 requiring an unscheduled reroute of the present object 110, then the present object 110 will be commanded to drop as scheduled to the target lower-loop cradle 404 at step 8. If the object successfully dropped to the lower loop, and if at step 9 it did not fail to drop from the lower loop 404 on command, then it will be routed at step 10 to either the proper collection bin 501, or to the loose-object loading area 518, as appropriate. If the object 110 was routed to the collection bin 501, then at step 11, then the control unit 125 will output a control signal commanding actuation of the solenoid to pull down the gate 706 over the appropriate drop point to the appropriate collection bin 501. Then, the dropped object 110 will be scanned with scanner 136 and the control unit 125 will provide information to the scanner pertinent to which sack 520 it should be placed in, if any. The object 110 will be placed in the appropriate sack at step 12 and placed on the conveyor 506, 527 for delivery to the sack loading area 512, 532 as ordered in step 13. If the object 110 was directed to the loose-object loading area 518, then it will proceed down the loose-object slide 514 to the loose-object conveyor 516 at step 14 for transport to the loading area 518 and final scanning with scanner 136 at step 17.

Returning to step 2, if the label is unreadable, then the object 110 will be diverted at the divert assembly 214 to the no-read processing area 220. If at step 15 the control unit 125 determines that it is at the end of the sort, then a control signal will direct the object to the manual processing area 226 for manual re-scanning with a scanner 136 at step 16 and manual transport to either its assigned collection bin 501 at step 11 for sacking at step 12 and delivery to the sack loading area 512, 532 at step 13, or to the loose-object loading area 518 at step 17 as the control unit signal transmitted to the scanner 136 dictates. If the at step 3, the object 110 is not dimensionally suitable for automatic processing, then a control signal will divert the object at the divert area 214 to the manual processing conveyor 224 for delivery to the manual processing area 226 at step 16. Then it will proceed to either the either the loose-object loading area 518 via steps 16 and 17, or to the sack loading area 512, 532 via steps 16, 11, 12, and 13 as previously described. If all drop opportunities are blocked at step 4, then the control unit 125 will determine at step 18 if a downstream object can be rerouted, and if so, the object 110 will proceed to step 5 and then as described above; but if not, then the object 110 will be directed to the recirculation conveyor 232 via the recirculation slide 230 or the failed-to-drop conveyor 312 and then to its final destination via the step 15 through 17 or 13 as described above. If at step 6, the drop point 800 is predictably blocked, and if at step 19 a rerouting is feasible, then the object 110 will be rerouted by the control unit 125 at step 22, and the object 110 will proceed to its destination via step 9 and succeeding steps as previously described. If a downstream reroute request is received at step 7, then the control unit 125 will determined the feasibility of such request at step 21 and if possible, the object 110 will be reassigned at step 22 and then routed to its final destination at step 9 and succeeding steps as previously described. If not possible, then the object 110 will proceed at step 8 to its originally assigned cradle 404 and then via step 9 and succeeding steps as previously described to its destination. Finally, if at step 9, the object 110 failed to drop from its lower loop 404, then the control unit will route it to the recirculation conveyor at step 20 and then onward to its final destination via succeeding steps as previously described.

As depicted in FIG. 7 and described above, the control system 120 as a number of inputs and outputs. The sensor assemblies provide inputs to the control unit 125. More specifically, information is gathered on each object 110 that enters the system 110. Initially, the scanner 134 obtains the destination information from the object's 110 label. Such information may contain a discrete destination code, for example. This information is sent to the control unit 125. In addition, the dimensioner 138 and scale 140 gather physical data on each object 125, including outer dimensions and weight. The dimensioner 138 and scale 140 deliver this data to the control unit 125. The sensors 132 are suitably positioned around the sorting system 100 wherever it is desirable to track passage of objects thereby to confirm proper operation. Such sensors report such passage or non-passage to the control unit 125. The control unit may receive other input information, including but not limited to the status of the conveyors, motors, and cradle-assemblies.

The control unit 125 processes the various inputs and controls the operation of the system 100 based on such information and the logic routines described herein. Outputs from the control unit include outputs to the induction assembly 200, to the upper-loop sorting matrix 300, to the lower-loop sorting matrix 400, to the destination assembly 500, and to the scanner 136. More specifically, the control unit 125 has any number of outputs M, where M is any positive integer, wherein M generally will be the number of mechanisms that the control unit 125 sends output signals to on the induction assembly 200. Examples of such mechanisms include but are not limited to the divert mechanisms 216, 222, 228, 234, the singulation mechanisms (not shown), and the discharge mechanisms. Similarly, the control unit 125 has any number of outputs N, where N is any positive integer, wherein N generally will be the number of mechanisms that the control unit 125 controls on the upper-loop sorting matrix 300. Examples of such mechanisms include but are not limited to the pull rod 303 solenoids which actuate the manipulation piece 712 puller, the motors and the divert mechanisms. While the operation of the pull rods themselves, and the conveyors is generally a function of the conventional gearing connecting the motor to such devices, it is within the teaching of the invention for the control unit to control the movements directly. In any event, the controller can stop the motor as in the case of a second fail-to-drop. Turning to the outputs to the lower-loop sorting matrix, the control unit 125 has any number of outputs L, where L is any positive integer, wherein L generally will be the number of mechanisms that the control unit 125 controls on the lower-loop sorting matrix 400. Examples of such mechanisms include but are not limited to the pull rod 403 solenoids which actuate the manipulation piece 712 puller, the motors and the divert mechanisms. So too, the control unit 125 has any number of outputs K, where K is any positive integer, wherein K generally will be the number of mechanisms that the control unit 125 controls on the destination assembly 500. Examples of such mechanisms include but are not limited to the diverters 510, 530 and one or more information displays (not shown) located around the collection bins 501. Finally, the control unit 125 sends output signals to the scanner 136 in order to provide feedback or instructions to the workers who perform the final scan.

While the invention has been illustrated and described in detail in the foregoing drawings and description, the same is to be considered as illustrative and not restrictive in character, it being understood that only preferred embodiments thereof have been shown and described and that all changes and modifications that come within the spirit of the invention are desired to be protected.

1. A system for sorting objects comprising:
a control unit,
a first conveyor sorting matrix,
a second conveyor sorting matrix located below said first sorting matrix,
said first and second sorting matrices are each adapted to receive and transport one or more objects to be sorted,
wherein said first matrix includes one or more primary discharge apertures for discharging said objects to said second matrix,
and wherein said second matrix includes one or more primary discharge locations for discharging said objects to one or more collection areas.

2. The system of claim 1, wherein the second conveyor matrix crosses under the first conveyor matrix.

3. The system of claim 2, wherein the first matrix and the second matrix each has a closed-circuit configuration.

4. The system of claim 3, wherein first conveyor matrix includes a primary discharge aperture in the vicinity of each point that it crosses over the second conveyor matrix.

5. The system of claim 4, wherein the closed-circuit configuration is an ellipse.

6. The system of claim 4, wherein the closed-circuit configuration is a quadrilateral.

7. The system of claim 4, wherein the objects move about the system in a series of steps.

8. The system of claim 7, wherein the steps are of a known fixed interval.

9. The system of claim 8, wherein the control unit utilizes the known interval that each object moves about the system in step-wise fashion to determine a current location of each object and to predict one or more future locations of each object.

10. The system of claim 9, wherein the control unit plans for each object its discharge at the one or more primary discharge apertures.

11. The system of claim 10, wherein the control unit commands the discharge of each object when each object arrives at its respective planned discharge aperture.

12. The system of claim 9, wherein the control unit plans for each object its discharge at the one or more primary discharge locations.

13. The system of claim 12, wherein the control unit commands the discharge for each object when each object arrives at its respective planned discharge location.

14. The system of claim 8, wherein the fixed interval includes a time component having a known duration.

15. The system of claim 8, wherein the fixed interval includes a distance component defining a known distance of object travel.

16. The system of claim 8, wherein the fixed interval includes a time component of known duration and a distance component of known distance of object travel.

17. The system of claim 16, wherein the time component duration is the same for objects on the first conveyor sorting matrix as for the objects on the second conveyor sorting matrix.

18. The system of claim 17, wherein objects on the first conveyor sorting matrix move according to a first value for the distance component, and wherein objects on the second conveyor sorting matrix move according to a second value for the distance component, and wherein said first value is not equal to said second value.

19. The system of claim 14, wherein the duration of the time component is up to about 6 seconds.

20. The system of claim 14, wherein the duration of the time component is about 6 seconds or greater.

21. The system of claim 15, wherein the distance component has a value of up to about 48 inches (1.2 m).

22. The system of claim 15, wherein the distance component has a value of about 48 inches (1.2 m) or greater.

23. The system of claim 18, wherein said first value is greater than about 40 inches (1 m), and wherein the second value is greater than about 30 inches (76 cm).

24. The system of claim 16, further comprising one or more secondary discharge apertures and one or more secondary discharge locations for any object that has failed to discharge as commanded.

25. The system of claim 24, wherein the first and second conveyor matrices each further comprise a plurality of adjacent closed-circuit tracks.

26. The system of claim 25, wherein each step includes a movement substep and an action substep, wherein all objects in the system move a distance equal to the distance component during the movement substep, and wherein one or more objects are discharged during the action substep.

27. A system for sorting objects comprising:
an induction assembly adapted to receive objects for sorting;
an upper sorting circuit adjacent to the induction assembly and adapted to receive objects therefrom;
a lower sorting circuit crossing under said upper sorting circuit and adapted to receive objects therefrom;
a destination assembly adapted for receiving objects from the upper and lower sorting circuits;
one or more sensor assemblies mounted to gather data on the one or more objects; and
a control apparatus connected to the induction assembly, the upper sorting circuit, the lower sorting circuit, and the one or more sensor assemblies and adapted to receive input information therefrom and to send output commands thereto to facilitate the delivery of each input object to the destination assembly.

28. The system of claim 27, wherein the upper circuit and the lower circuit are each ellipses.

29. The system of claim 27, wherein an object on the upper circuit has a primary discharge opportunity to the lower circuit each time the upper circuit crosses the lower circuit.

30. The system of claim 29, wherein the objects move about the system from the induction assembly to the destination assembly in a series of steps.

31. The system of claim 30, wherein the steps are of a known fixed interval.

32. The system of claim 31, wherein the control unit utilizes the data gathered by the one or more sensor assemblies and the known interval that each object moves about the system in step-wise fashion in order to determine a current location of each object and to predict one or more future locations of each object.

33. The system of claim 32, wherein the control unit plans for each object its one or more primary discharge opportunities.

34. The system of claim 33, wherein the control unit diverts at the induction assembly any object that the control unit determines will be unable to discharge at any of the one or more primary discharge opportunities.

35. The system of claim 34, wherein the upper circuit further comprises one or more secondary discharge opportunities.

36. The system of claim 35, wherein the control unit commands an object to discharge at one of the secondary discharge opportunities in the event such object failed to discharge at one of the primary discharge opportunities.

37. The system of claim 36, wherein the upper circuit and the lower circuit each include a plurality of adjacent tracks.

38. The system of claim 37, wherein said adjacent upper tracks are substantially perpendicular to said adjacent lower tracks.

39. The system of claim 38, wherein the objects are discharged by gravity.

40. The system of claim 39, wherein the induction assembly includes one or more diverging end portions adapted to deliver objects to one or more upper tracks.

41. The system of claim 40, wherein the control system commands an object to divert in the event that the control system cannot plan a drop at any primary discharge location on any track served by said diverging end portions.

42. The system of claim 41, wherein discharges may occur at each of the primary and secondary discharge opportunity throughout the system during the same step.

43. The system of claim 37, further comprising a plurality of receptacles carried by each track and adapted to transport objects to be sorted around said tracks, each receptacle comprising a pair of spaced apart side pieces, a slanted floor portion sandwiched between the side pieces, and a gate portion movably attached to the floor portion and extending outwardly away therefrom.

44. The system of claim 43, wherein an object to be sorted enters the receptacle by sliding down its floor portion.

45. The system of claim 43, wherein an object to be sorted enters the receptacle by sliding down its gate portion.

46. The system of claim 43, wherein an object to be sorted enters the receptacle by sliding down its bottom portion or its gate portion.

47. The system of claim 46, wherein the movable gate portion lowers toward the floor portion to allow an object inside the receptacle to be discharged by sliding down and out of the receptacle.

48. The system of claim 47, wherein the upper circuit receptacles align with the lower circuit receptacles to allow objects to be discharged to slide out of the upper circuit receptacle down into the lower circuit receptacle aligned below.

49. The system of claim 47, wherein the lower circuit receptacles align to discharge objects thereto.

50. An apparatus for receiving and discharging objects to be sorted by a sorting system, the apparatus comprising:
a pair of spaced apart side pieces,
a slanted floor portion sandwiched between the side pieces, and
a gate portion movably attached to the floor portion and extending outwardly away therefrom.

51. The apparatus of claim 50, wherein an object to be sorted enters the apparatus by sliding down the gate portion.

52. The apparatus of claim 50, wherein an object to be sorted enters the apparatus by sliding down the floor portion.

53. The apparatus of claim 50, wherein an object to be sorted enters the apparatus by alternately sliding down the gate portion or the floor portion.

54. The apparatus of claim 53, wherein the movable gate portion moves downwardly to allow the object to slide down and out.

55. A system for sorting objects comprising:
an elevated induction line comprising a longitudinally extending row of conveyor cells adapted to receive and transport from one cell to the next ,one or more objects to be sorted,
said induction-line conveyor cells including one or more accumulation cells, one or more information-gathering cells, one or more divert cells, and a discharge cell,
a plurality of longitudinally extending, upper sorting ellipses positioned adjacent to said induction line and lower in elevation relative thereto,
a plurality of transversely extending, lower sorting ellipses which are oriented beneath said upper sorting ellipses and generally perpendicular thereto,
a plurality of sort destinations positioned generally beneath the upper and lower ellipses and configured to receive objects therefrom,
a control apparatus comprising a control unit and a plurality of sensor arrays,
said information-gathering cell being configured with one of said sensor arrays adapted to determine an object's particular sort information including its delivery information, its outer dimensions and its weight,
said sort information-gathering cell sensor array comprising a label reader, a dimensioner, and a scale,
said upper sorting ellipses and said lower sorting ellipses each comprising a plurality of receptacles adapted to receive said objects and transport them to their respective sort destinations
said receptacles comprising a pair of spaced apart, upwardly extending sides, a slanted floor portion sandwiched between the spaced-apart sides, a gate portion movably attached to the floor portion and extending outwardly away therefrom at substantially a right angle thereto,
wherein said information-gathering cell sensor array sends said sort information to said control apparatus for processing and the determination of a path of travel for each object from the induction line to one of the final destinations.

56. A method of sorting objects comprising the steps of:
providing a control unit to control the sort process,
providing a first sorting matrix,
providing a second sorting matrix located below said first sorting matrix,
providing a plurality of collection destinations,
transferring an object to be sorted from the first matrix to the second matrix,
transferring said transferred object from the second matrix to one of the collection destinations,
providing for one or more divert destinations in the event an object cannot be transferred from the first matrix to the second matrix, and
providing for one of more divert destinations in the event an object cannot be transferred from the second matrix to the collection destination.
